(19) United States
(12) Patent Application Publication
(10) Pub. No.: US 2015/0278961 A1
(43) Pub. Date: Oct. 1, 2015

(54) System and method of creating social networks with temporary access

(71) Applicant: Mike Ratti, Mt. Airy, MD (US)

(72) Inventor: Mike Ratti, Mt. Airy, MD (US)

(21) Appl. No.: 13/999,819

(22) Filed: Mar. 25, 2014

(51) Int. Cl. G06Q 50/00; G06Q 30/00; G06Q 50/14

(52) U.S. Cl. CPC G06Q 50/01; G06Q 50/14; G06Q 30/00

(57) ABSTRACT

A system and method of creating a social network having members based on common travel criteria, where the members are provided access to the social network for a pre-determined access period. A computer processor accesses a member account database and establishes a temporary social network among multiple members based on the travel information of the members. The computer processor permits access by each member for a predetermined access period and is capable of being accessed by a member via the world wide web through use of a computer device. Upon expiration of a member's access period, the social network will not permit the member to access the social network.

In most social networks, a user joins the social network by accessing the social network via the internet through use of a computer and initially registering to join the social network by entering basic user information. Once joined the user has the ability to engage in various functions such as viewing profiles of other members of the social network, creating a personal network of selected users, joining groups and other functions offered by the particular social network. Once a user joins a social network they typically remain a member until the user decides to terminate their membership.

Most online social network services also allow users to organize themselves into groups. Such groups may be based on a theme common to members of the group, such as, for example, common interests, causes, or shared circumstances. In these groups, messages and other data may be exchanged that is specifically applicable to or intended for the membership of that group. Some groups may allow any user to join, while other “private” groups may require that potential group members be invited, or approved, by a moderator or existing member of the group before they can join the group. The organization of users into different groups within an online social network service may serve the purpose of focusing the exchange of information related to a specific topic or social cause to its intended recipients and matching members with common interests.

There are a number of different known ways of creating groups within a social network. For example, U.S. Pat. No. 8,601,055 entitled Dynamically Managing a Social Network Group (the “'055 Patent”), describes a method for dynamically managing a social network group performed by a group management system comprising at least one physical processing apparatus, where the method includes receiving, with the group management system, data from a number of source providers over a computer network; identifying a basis for creating a new social network group from the data with the group management system; creating the new social network group with the group management system; and automatically inviting a number of members to join the new social network group with the group management system, each of the members being associated with the basis identified in the data for creating the new social network group. As set forth in the '055 Patent, the basis for creating a new social network group is determined from data from a number of source providers where the data can be news, articles, microblogging updates, social networks status updates, blog posting and public social network communications.

The social network described in the '055 patent, along with other known social networks, like Facebook, Linked-In and Twitter, involve permanent membership, in that membership does not have a defined expiration date or time. There does not exist, however, a system for creating, from a pre-existing group of people, a temporary social network among multiple members selected from such pre-existing group of members based on the members travel information, such as their departure time or location or their arrival time or location, where the social network is temporary in that the social network is designed to expire at a predetermined time or its member group is reformed constantly or at predetermined intervals.

Most major commercial transportation carriers, including most major airlines and rail providers, have rewards programs for rewarding those who frequently use their transportation service. While membership in these rewards programs may be open to the general public it is the frequent traveler, and, in particular, the frequent business traveler, who reaps the most rewards from the rewards program. Membership typically involves the submission of an application with basic registration information to the carrier who, upon acceptance of the application, establishes an account for the new member. The account typically includes an account number (the “Travel Account Number”) that is associated with the member's registration information (the “Travel Account Information”) and the member's travel history with the carrier, all of which is kept by the carrier in an electronic database which will hereafter be referred to as the “Rewards Program Database”. Once registered, the member may present the Travel Account Number to the carrier whenever using the carrier's services and the carrier will use the Travel Account Number to retrieve the Travel Account Information, to track the member's travel, to update the members account, and to provide the member with rewards for achieving certain travel milestones. These rewards programs are well known in the industry and a major airline carrier, such as Southwest, United, American or US Airways, may have rewards programs with tens of millions of members.

Many of the frequent business travelers who belong to one or more travel rewards programs also belong to public social networks such as Linked-In, FaceBook and Twitter. It has not been appreciated, however, that no public social networks provide the frequent business traveler with a private social network where membership in the private social network is based on common travel plans, such as a common destination, whereby the frequent business travelers can communicate with other frequent business travelers with common travel plans during a pre-determined window of time before, during or after the date of travel.

### BRIEF SUMMARY

In an embodiment, described is a system and method for creating a temporary social network of people, said system comprising a member account database containing multiple member accounts, each said member account including member registration information and member travel information for a member; a computer processor for accessing said member account database and for establishing a temporary social network among multiple members based on said member travel information, said social network permitting access by each said multiple member for a predetermined access period; and said computer processor capable of being accessed by a member via the world wide web through use of a computer device, whereby, through use of a computer device, said multiple members may access said computer processor via the world wide web to thereby access said temporary social network during the access period, and whereby, upon expiration of the access period, the social network will not permit access by one or more of the multiple members.

In an embodiment, described is a system and method for creating a series of temporary social networks, said system comprising: a member account database containing multiple member accounts, each said member account including member registration information and member travel information for a member; a computer processor for accessing said member account database and comparing member travel information of multiple member accounts with selected travel criteria to thereby identify member accounts with member travel information matching said selected travel criteria and for establishing a temporary social network among the multiple members associated with the identified member accounts, such that each said multiple member is permitted to access said temporary social network during a predetermined access period; and said computer processor capable of being accessed via the world wide web through use of a computer device, whereby, through use of a computer device, said multiple members may access said computer processor via the world wide web to thereby access said temporary social network during the access period, whereupon expiration of the access period, the social network will not permit access by one or more of said multiple members, where said member account database receives updates to the member travel information and said computer processor is programmed to periodically compare member travel information of multiple member accounts with said travel criteria to thereby identify a second set of member accounts with member travel information matching said travel criteria and thereafter establish a second temporary social network among a second set of multiple members associated with the second set of identified member accounts, where said second set of multiple members is permitted to access said second temporary social network during a predetermined access period.

In another embodiment, described is a system and method for creating multiple social networks, said system comprising: a member account database containing multiple member accounts, each said member account including member registration information and member travel information for a member; a computer processor for accessing said member account database and creating multiple member groups based on a comparison of the member travel information of multiple member accounts with selected travel criteria, each said member group having members with at least one common travel criteria, said computer processor for establishing a temporary social network for each member group, each said temporary social network being established with an access period, whereby said computer processor permits access to each temporary social network by each member of its associated member group during wide web through use of a computer device, whereby, through use of a computer device, a member of a member group may access said computer processor via the world wide web to thereby access the temporary social network of the member group to which member belongs, where each temporary social network expires upon expiration of the temporary social network's access period.

Embodiments are described herein without limitation in terms exemplary systems and methods for creating, from a pre-existing group of people, a temporary social network among multiple members selected from such pre-existing group of members based on the members travel information, such as their departure time or location or their arrival time or location, where the social network is temporary in that the social network is designed to expire at a predetermined time or its member group is reformed constantly or at predetermined intervals. For example, exemplary embodiments of a social network whereby a transportation carrier may use the travel information of a pre-selected group of travelers, such as members of a rewards program, to create a private temporary social network that allows travelers with common travel itineraries to network via a private social network during a predetermined period of time before, during or after the travel date. The terminology and examples herein are for the purpose of describing particular embodiments only and do not limit the scope of the invention.

### BRIEF DESCRIPTION OF THE SEVERAL VIEWS OF THE DRAWINGS

The accompanying drawings illustrate various embodiments of the principles described herein and are part of the specification. The illustrated embodiments are merely examples and do not limit the scope of the claims.

FIG. 1(a) is a diagram showing an illustrative overview of the social network, according to one embodiment of the principles described herein.

FIG. 1(b) is a diagram showing an illustrative overview of the social network, according to one embodiment of the principles described herein.

FIG. 2 is a diagram showing an illustrative database for the registration information and the travel information, according to one embodiment of the principles described herein.

FIG. 3(a) is a table of information representing one example of the access period of multiple members of the social network

FIG. 3(b) is a timeline showing the relative access periods of members from the table in FIG. 3(a).

FIG. 4(a) is a table of information representing one example of the access period of multiple members of the social network.

FIG. 4(b) is a timeline showing the relative access periods of members from the table in FIG. 4(a).

FIG. 4 is a diagram showing an illustrative overview of the interconnections of members of the social network, according to one embodiment of the principles described herein.

FIG. 5 is a diagram showing an illustrative user interface for a member of the social network, according to one embodiment of the principles described herein.

FIG. 6 is a diagram showing an illustrative format of the member profile section of the user interface.

FIG. 7 is a diagram showing an illustrative format of the public social network information section of the user interface.

FIG. 8 is a diagram showing an illustrative format of the public social network information section of the user interface.

FIGS. 9(a)-9(g) show a representative implementation of the user interface of the social network.

FIG. 10 illustrates an exemplary structure of a server, system, or a terminal according to an embodiment.

### DETAILED DESCRIPTION

It will be appreciated by those ordinarily skilled in the art that the foregoing brief description and the following detailed description are exemplary (i.e., illustrative) and explanatory of the subject matter as set forth in the present disclosure, but are not intended to be restrictive thereof or limiting of the advantages that can be achieved by the present disclosure in various implementations. Additionally, it is understood that the foregoing summary and ensuing detailed description are representative of some embodiments as set forth in the present disclosure, and are neither representative nor inclusive of all subject matter and embodiments within the scope as set forth in the present disclosure. Thus, the accompanying drawings, referred to herein and constituting a part hereof, illustrate embodiments of this disclosure, and, together with the detailed description, serve to explain principles of embodiments as set forth in the present disclosure.

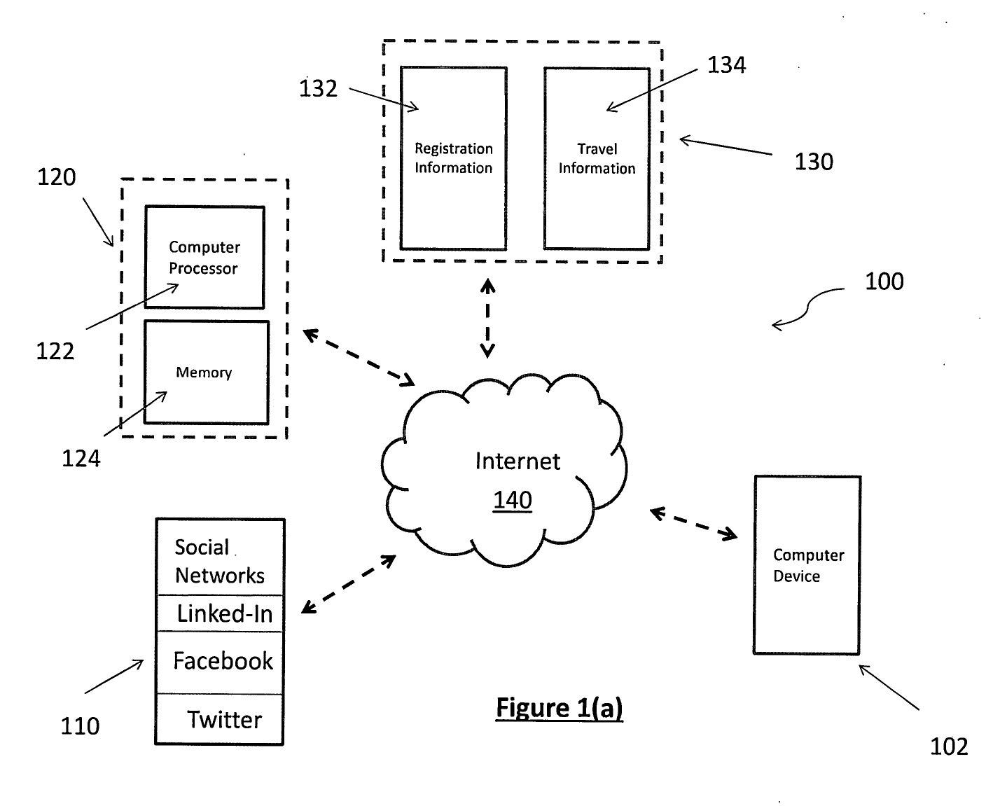

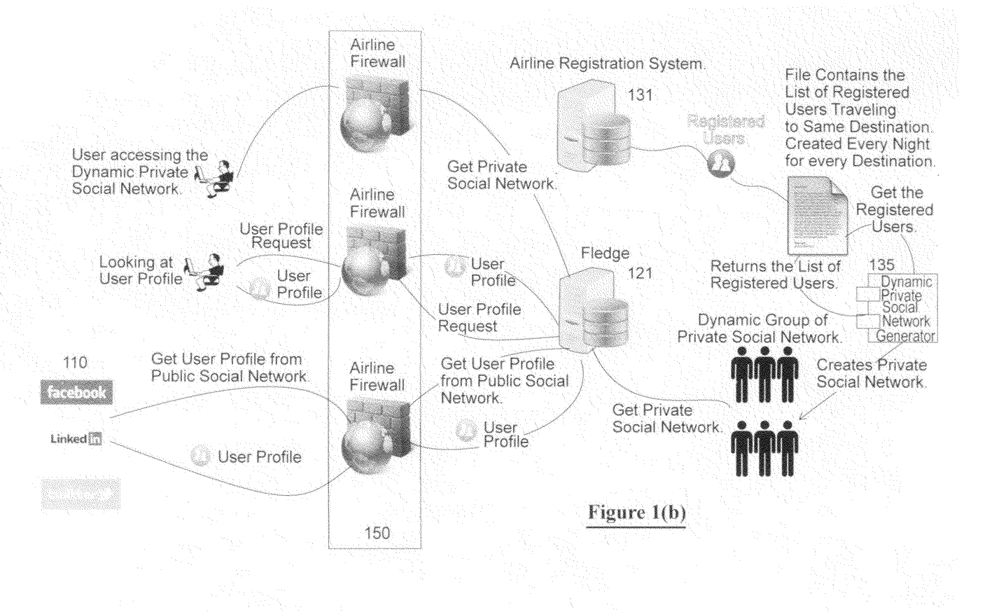

FIG. 1(a) is a diagram showing an illustrative overview of the social network according to an exemplary embodiment. With reference to FIG. 1(a), the social network (100)includes a computer server (120) having a computer processor (122) and computer memory (124) and a member account data base (130) for storing multiple member accounts, where each of the member accounts includes member registration information (132) and member travel information (134) and a database for storing travel information (134). With continued reference to FIG. 1(a), according to an embodiment, the computer processor (122) is capable of accessing the member account database (130) and comparing member travel information of multiple member accounts with pre-selected travel criteria to thereby identify member accounts with travel information matching the pre-selected travel criteria. Once the member accounts are identified, the computer processor (122) receives registration information (132) associated with the identified member accounts and establishes a private, temporary social network among the members associated with the identified member accounts, such that those members may access the temporary social network during a pre-determined access period. The computer processor (122) is capable of being accessed via the internet (140) through use of a computer device (102), whereby, through use of a computer device (102), the members that comprise the temporary social network may access the computer processor (122) via the internet (140) to thereby access the temporary social network during the pre-determined access period. Upon expiration of the access period, the members will not be permitted to access the social network.

Upon accessing the social network, the computer processor (120) will present a member-specific user interface for display on the computer device (102), as is common with social networks. The computer processor (120) is capable of accessing, via the internet (140), various public social networks (110) (such as LinkedIn, Facebook, MySpace and Twitter) such that, when a member accesses the private social network, the computer processor (120) accesses one or more of the public social networks (110) and uses the member registration information (132) to access the member's account within the public social network (110) to thereby access information within the member's public social network account. The computer processor (120) selectively displays the member's public social network information on one or more user interfaces of members of the private social network.

As will be appreciated by one of skill in the art, the computer server (120) and the member account database (130) may be capable of connecting to the internet such that they can be accessed by each other and by other remote devices. This connection may be made wirelessly (whether through WiFi, Bluetooth, Cellular or otherwise) or by hard-wire (such as, for example through a coaxial or fiber optic cable) or by any means known in the art for enabling communication with a remote device via the internet. Furthermore, as will be appreciated, the member account database (130) and the computer server (120) need not be remote from each other and may be comprised of single computer hardware device or multiple computer hardware devices local to each other. The member account database (130) and the computer server (120) may be enabled by any configuration of hardware and software whereby the computer processor (122) may access the member account database (130) to identify member accounts with common travel criteria.

As used herein, the network should be broadly construed to include any one or more of a number of types of networks that may be created between devices using an internet connection, a LAN/WAN connection, a telephone connection, a wireless connection, a short message system (SMS), and so forth. Each of the terminals, servers, and systems may be, for example, a server computer or a client computer or client device operatively connected to network, via bi-directional communication channel, or interconnector, respectively, which may be, for example a serial bus such as IEEE 1394, or other wire or wireless transmission medium such as 3G or 4G networks. The terms “coupled with,” “operatively connected,” “operatively coupled,” and “communicatively coupled”, as used herein, mean that the elements so connected or coupled are adapted to transmit and/or receive data, or otherwise communicate. This connection/coupling may or may not involve additional transmission media, or components, and may be within a single module or device or between the remote modules or devices. The terms “connected” and “coupled” thus include directly connected to or indirectly connected through one or more intermediate components. Such intermediate components may include both hardware and software based components.

It should be appreciated that a typical system can include a large number of connected computers (e.g., including server clusters), with each different computer potentially being at a different node of the network. The network, and intervening nodes, may comprise various configurations and protocols including the internet, World Wide Web, intranets, virtual private networks, wide area networks, local networks, private networks using communication protocols proprietary to one or more companies, Ethernet, WiFi and HTTP, cloud and cloud based services, and various combinations of the foregoing. Such communication may be facilitated by any device capable of transmitting data to and from other computers, such as modems (e.g., dial-up, cable or fiber optic) and wireless interfaces.

The terminals, computer devices, and systems are adapted to transmit data to, and receive data from, each other via the network. The terminals, servers, and systems typically utilize a network service provider, such as an Internet Service Provider (ISP) or Application Service Provider (ASP) (ISP and ASP are not shown) to access resources of the network.

The computer devices (102) can be any computer device capable of accessing the internet, as is commonly known in the industry, such as a desktop computer, a laptop computer, a computer tablet or a handheld mobile device. Accordingly, although each of the above described terminal, server, and system may comprise a full-sized personal computer, the system and method may also be used in connection with mobile devices capable of wirelessly exchanging data with a server over a network such as the internet. For example, a terminal, client device or user device may be a wireless-enabled PDA such as an iPhone, an Android enabled smart phone, a Blackberry phone, an computerized watch, an iPad or Android enebled tablet, or any another internet-capable wireless device as known in the art.

As will be appreciated by one of skill in the art, the process of comparing member travel information (134) with pre-selected travel criteria may be performed by the computer processor (122) or by another computer processor having access to the member account database, as long as the computer processor (122) receives the registration information (132) of the identified member accounts.

FIG. 1(b) is a diagram showing an illustrative overview of the social network according to an exemplary embodiment. With reference to FIG. 1(b), the social network (100) includes a computer server (121), an airline registration system (131) with a member account data base and a social network generator (135) within the computer firewall (150) of an airline. Upon prompting, the social network generator (135) requests from the airline registration system (131) a list of member accounts with travel information matching the pre-selected travel criteria. Once received, the social network generator (135) creates a social network that is hosted by the computer server (121). The computer server (121) requests and receives information from one or more public social networks (110) and may be accessed by the members of the social network during their respective access periods. Upon expiration of the access period, the members will not be permitted to access the social network.

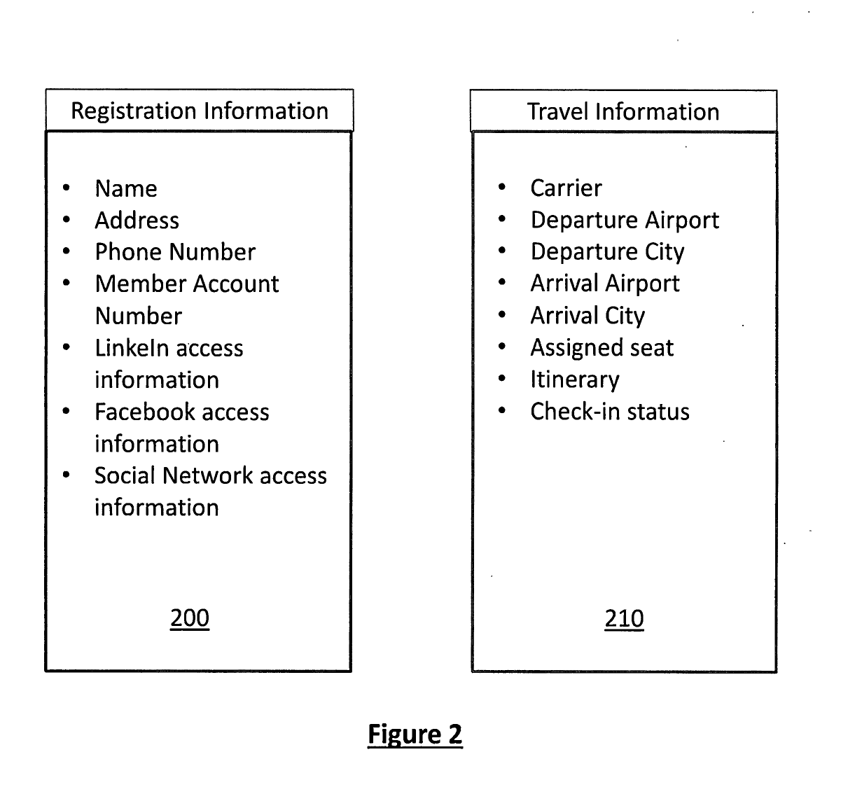

Referring to FIG. 2, the registration information (200) may include the member's name, address, phone number, e-mail address, member account number, public social network access information (e.g., usernames and passwords) and any other profile information commonly associated with social networks. With continued reference to FIG. 2, the travel information (210) may include the member's travel itinerary information, including, without limitation, departure airport, departure city, arrival airport, arrival city, seat location, flight information, check-in status or hotel location.

The common travel criteria may be established by the social network administrator and input to the computer processor (122) for use in identifying member accounts with common travel criteria. For example, the administrator of a commercial airline operating the private social network may establish the common travel criteria as all flights scheduled to arrive in New York City on July 4th. With this information, the computer processor (122) would, when prompted to do so (whether by the administrator or in response to computer programming), search the member travel information (210) within the member accounts to identify members scheduled to travel on flights that arrive in New York City on July 4^{th} and then establish a private social network among those members as described herein. The computer processor (122) would, in conjunction with establishing the private social network, permit access to the private social network (but only during the access period) by the members identified as scheduled to travel on a flight to New York on July 4^{th}.

Permission to access the private social network would be limited to an access period established by the administrator. The administrator may establish one access period for the entire group or may establish an access period for each member. Continuing with the example, the administrator may establish a global access period whereby the members identified as scheduled to travel on a flight to New York on July 4^{th} are permitted to access the private social network during the 24-hour period of July 4^{th}, or may establish an access period for each member whereby each member may access the private social network during the period of time, for example, beginning 12 hours before the scheduled departure time of the member's flight and ending, for example, 12 hours after the scheduled departure time of the member's flight. In the former case, the group of members having access to the private social network would be fixed for the 24 hour period, while in the latter case, access to the private social network would be “rolling” in that each member would have an individual access period that my overlap the access period of other members.

Furthermore, in either case, it will be appreciated that the social network may be established on a continuous basis for the purpose of serving members if and when they are scheduled to travel to New York City, such that each member is permitted access during an access period established based on when they are scheduled to travel to New York City. In any event, it should be appreciated that the access period is temporary, can be any access period as determined by the system administrator and can vary from member to member. Hereafter, the social network established for serving members if and when they are scheduled to travel to New York City shall be referred to as the New York City social network.

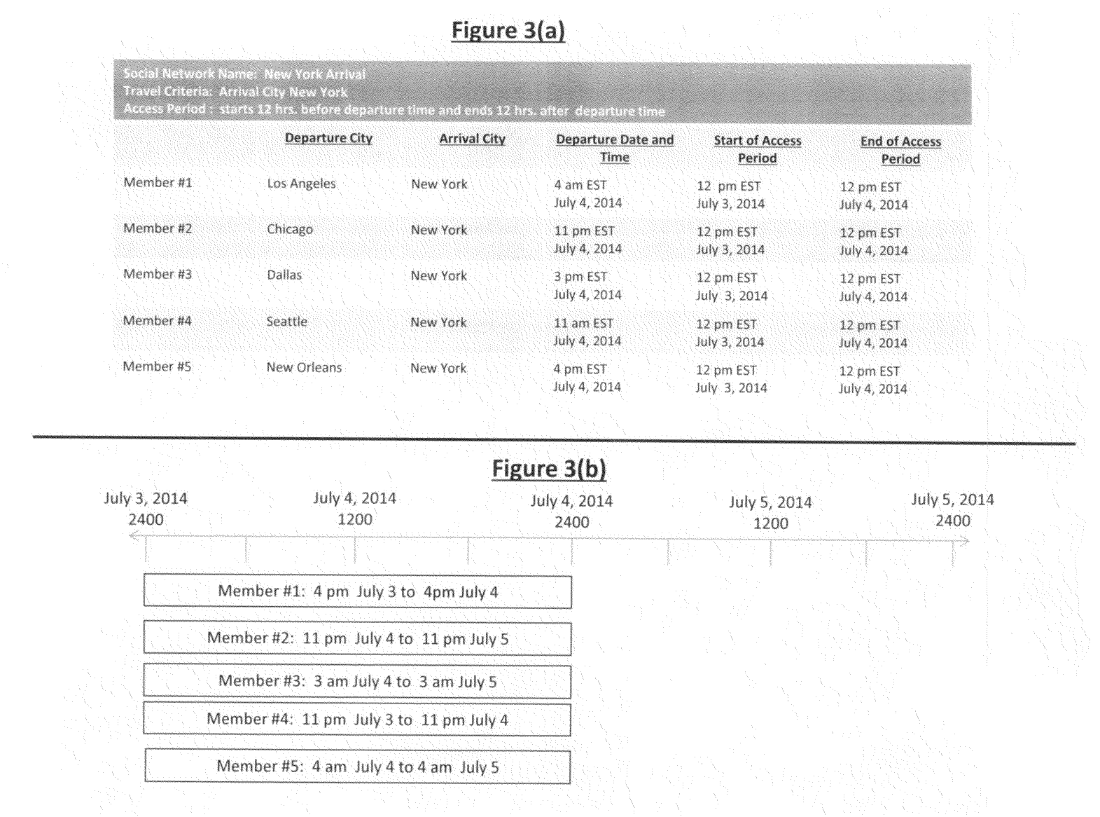

FIGS. 3(a) and 3(b) illustrate the former example where the system administrator establishes a common access period for all members of the social network on, for example, a particular day. With reference to FIG. 3(a), according to the example, five passengers are scheduled to travel with the same airline carrier on July 4, 2014, each scheduled to depart at different times from different cities and to arrive at different times in New York City. The system establishes each passenger as a member of the New York City social network each with an access period starting at midnight on July 3, 2014 and ending on July 4, 2014.

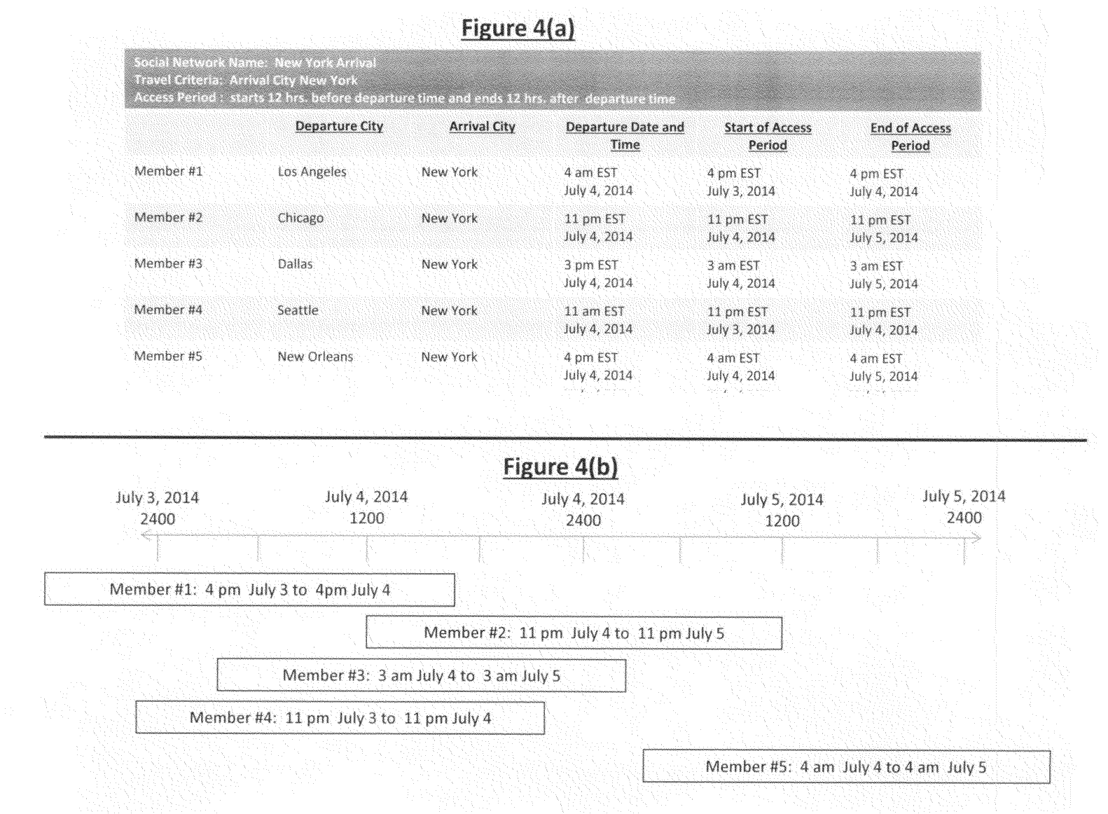

FIGS. 4(a) and 4(b) illustrate the latter example where the system administrator establishes an access period for each member. With reference to FIG. 4(a), according to the example, five passengers are scheduled to travel with the same airline carrier on July 4, 2014, each scheduled to depart at different times from different cities and to arrive at different times in New York City. The system establishes each passenger as a member of the New York City social network each with an access period beginning 12 hours before the scheduled departure time of the member's flight and ending 12 hours after the scheduled departure time of the member's flight.

As will be appreciated, the computer processor (122) may create multiple social networks; each social network based on its own unique travel criteria. For example, the administrator may create a private social network for each of five cities, where membership in a particular social network is granted to members travelling to the destination city and access to the social network is permitted during the established access period. In this manner, an airline carrier can create multiple private social networks, each with membership limited to members travelling to a particular city, where each private social network permits access by each of its members during a predetermined access period.

In one embodiment of the system, the “temporary” aspect of the private social network resides in the fact that each member's access to the private social network is limited in time such that membership in the social network is routinely updated. In another embodiment, the “temporary” aspect resides in the expiration of the private social network entirely.

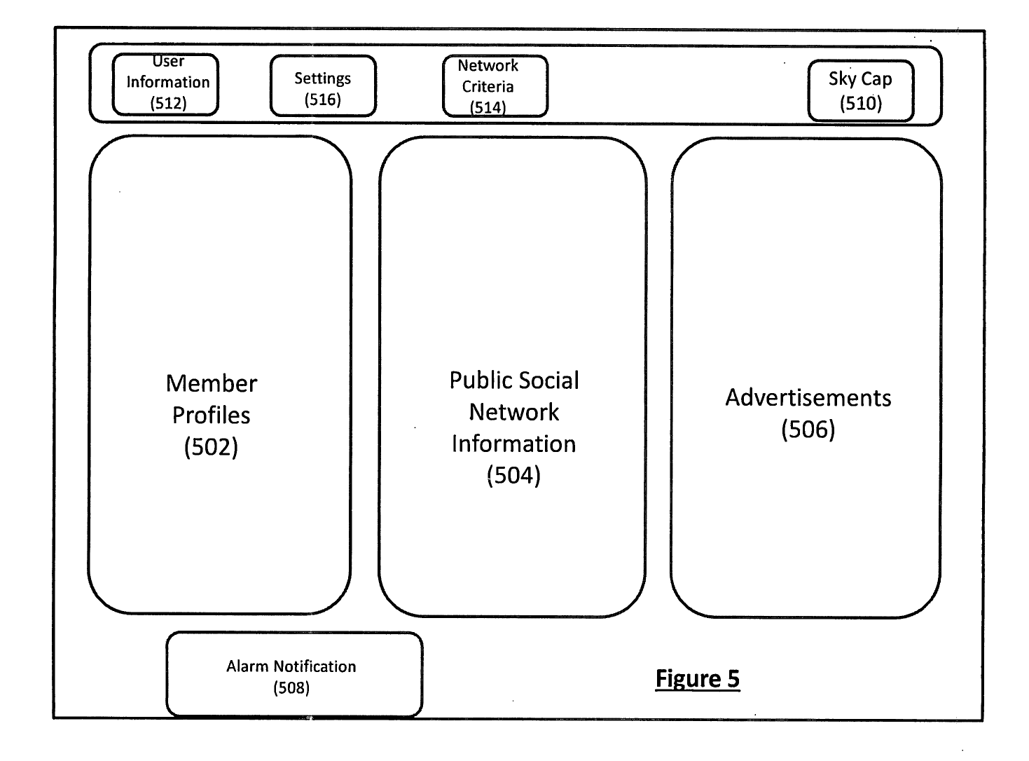

FIG. 5 is a diagram showing an illustrative user interface for a member of the social network, according to one embodiment of the principles described herein. With reference to FIG. 5, a representative user interface (500) generated by the computer processor (122) for display on the computer device (102) functions as the user interface for the member when accessing the private social network. The representative user interface (500) displays a member profile section (502) that displays the profile information of other members of the social network that are logged in to the social network; a public social network information section (504) that display public social network information of a selected member of the social network; an advertisement section (506) that displays commercial advertisements; a user information section (512) , a settings section (516) that allows the user to access various user interface functions such as a “help” function, a language setting function, and a log-out function; a sky cap section (510) that enables the user to search business venues based the destination; and an alarm notification section (508) that enables the user to send an alarm message in the event of an alarm event. As will be appreciated, the user interface (500) is illustrative only and should not be viewed as limited to the particular information, configuration, layout or format shown.

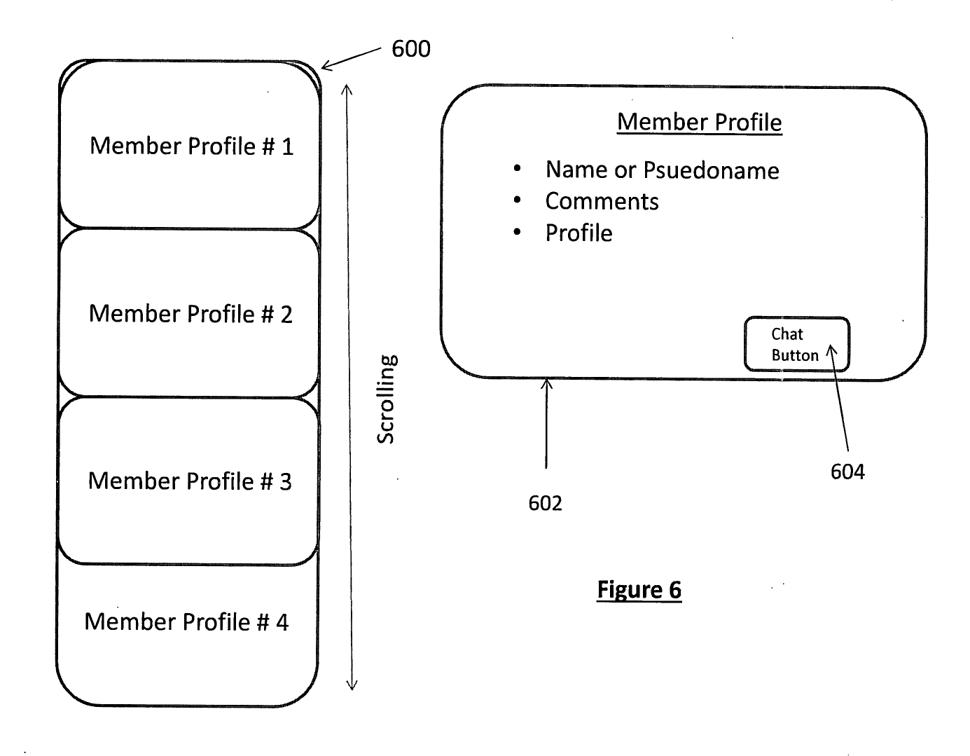

FIG. 6 is a diagram showing an illustrative format of the member profile section of the user interface. Referring to FIG. 6, the member profile section (600) may include multiple member profiles (602), each with information about the member, including member name or pseudo-name, member profile comments, employer, and job title. The member profile section (600) may be enabled with a scrolling feature so the user can selectively scroll up and down to thereby scroll through the members of the social network. Each member profile may contain a chat feature (604) whereby when selected the computer processor (122) enables a communication channel between the user and the selected member thereby enabling a text communication between the user and the selected member.

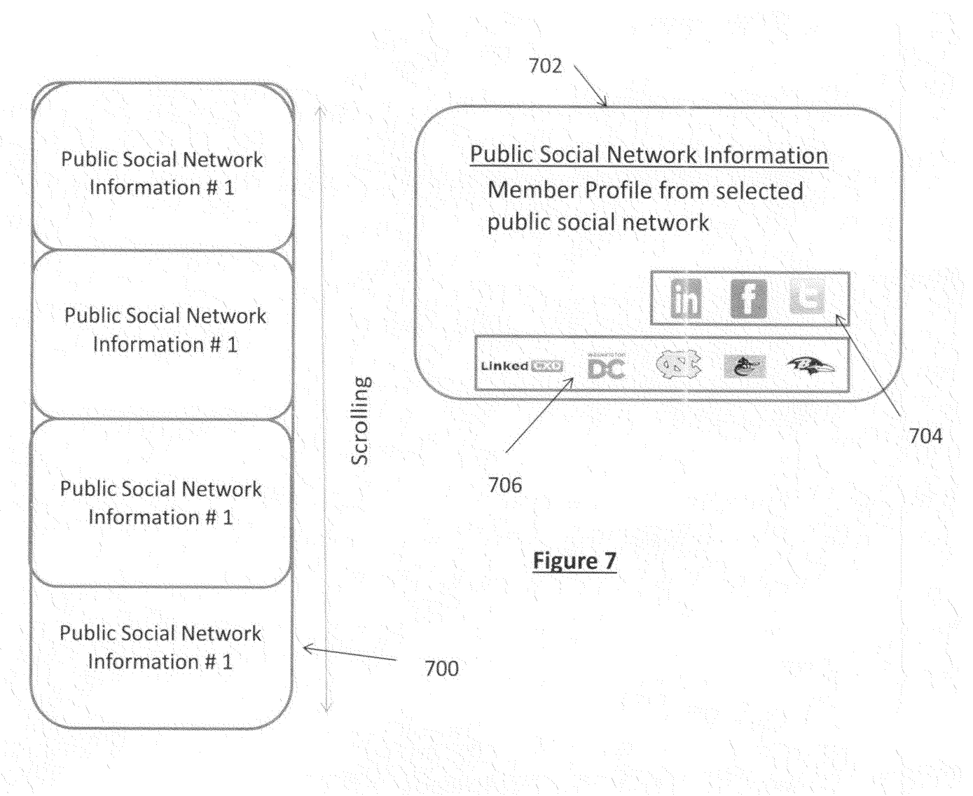

FIG. 7 is a diagram showing an illustrative format of the public social network information section (700) of the user interface. Referring to FIG. 7, the member public social network information section (700) may include public social network information (702) of one or more members, which, in a first mode, is displayed in abstracted form. The public social network information section (702) may be enabled with a scrolling feature so the user can selectively scroll up and down to thereby scroll through the public social network information of the members of the social network. The public social network information (702) may include a public social network indicator bar (704) that displays the logos of the public social networks to which the selected member belongs and to which the computer processor (122) is authorized to access. Upon selection by the user of one of the public social networks shown in the public social network indicator bar (704), the computer processor will access information of the selected public social network and display it in the user interface (500).

Also included in the public social network information (702) is a favorites bar (706) which display the logos of the members favorite organizations and association such as sports teams, universities, public social network groups and professional associations to which the member belongs, and the like. In one embodiment of the system, the user may select one of the logos in the favorites bar (706) thereby prompting the computer processor (122) to filter the members of the social network based on those members having the selected logo in the favorites bar (706) and provide the filtered information for display on the member's computer device (102).

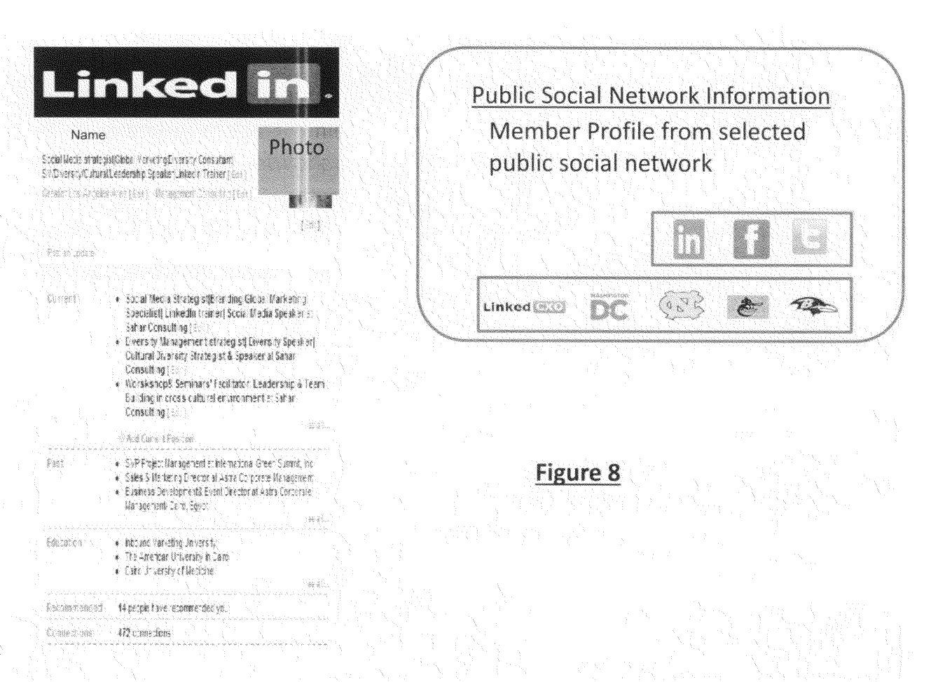

As previously stated, upon selection by the user of one of the public social networks shown in the public social network indicator bar (704), the computer processor will access information of the selected public social network and display it in the user interface (500). FIG. 8 shows an illustrative example of the public social network information section 504 upon selection of one of the public social networks shown in the public social network indicator bar (704). In this example, the user selected Linkedln from the public social network indicator bar thereby prompting the computer processor (122) to display the selected member's linked-in information (800).

As will be appreciated, it is not necessary that the public social network indicator bar (704) or the favorites bar (706) be displayed within the public social network information section (504) of the user interface. One or both of these bars may, for example, be displayed in the member profile section (502), or in any other area of the user interface.

Referring again to FIG. 5, the advertisements section (506) may be populated with commercial advertisements as is well known in the art. In one example, the computer processor would interact with an on-line advertising provider, such as Google AdSense, to present advertisements in the advertisement section (506) of the user interface (500).

The sky cap section (510) enables the user to perfrom a search of the internet for information related to business centric venues including, for example venues related to the users destination location. This feature may include dropdown filters related to Tradeshows, Sports Tickets, Athletic Clubs, Golf Courses, Steak Houses, Shows, Malls, Spas, or other venues of interest.

The alarm notification feature (508), when activated by a user, sends an alarm message to the computer processor (122) for forwarding to a recipient. The alarm notification (508) is intended to be activated upon the occurrence of an alarm event such as the occurrence of suspicious or dangerous behavior on the transport vehicle. When activated, alarm notification (508) may send a simple alarm notice to the recipient or may provide the user with the option of preparing a message or may create a text communication channel between the user and the recipient. The recipient may be any emergency management organization such as the transportation carrier's internal emergency management organization or any public emergency management organization.

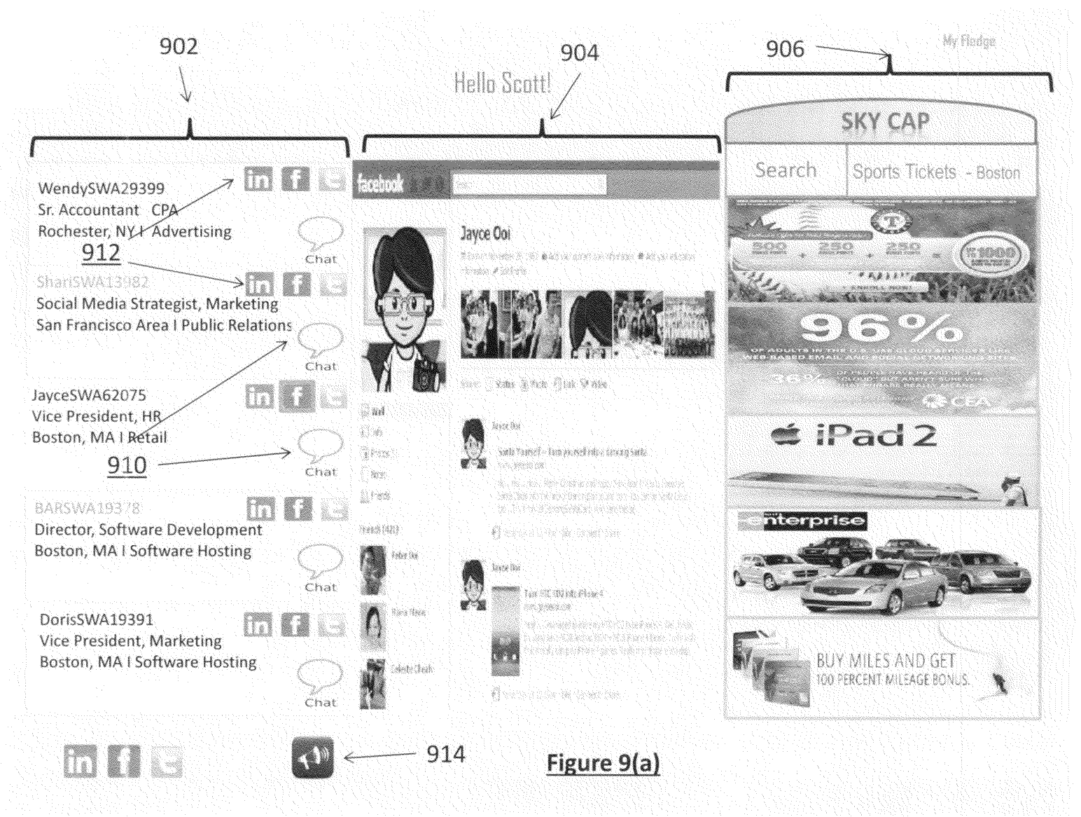

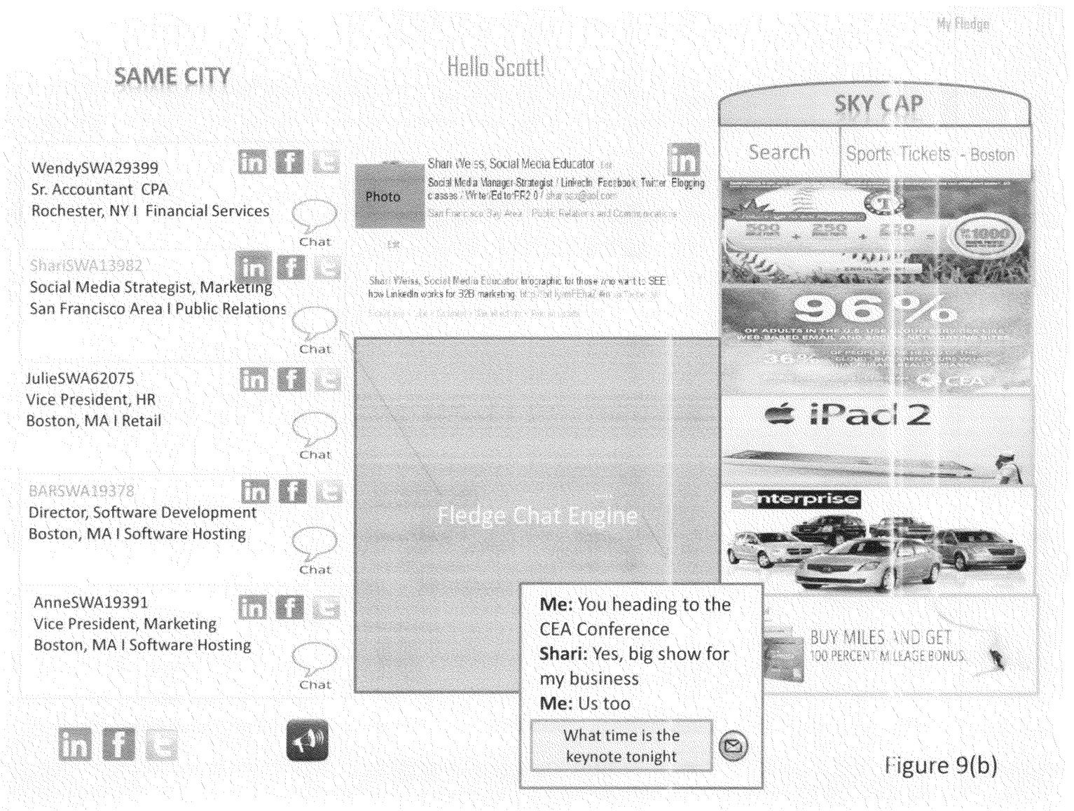

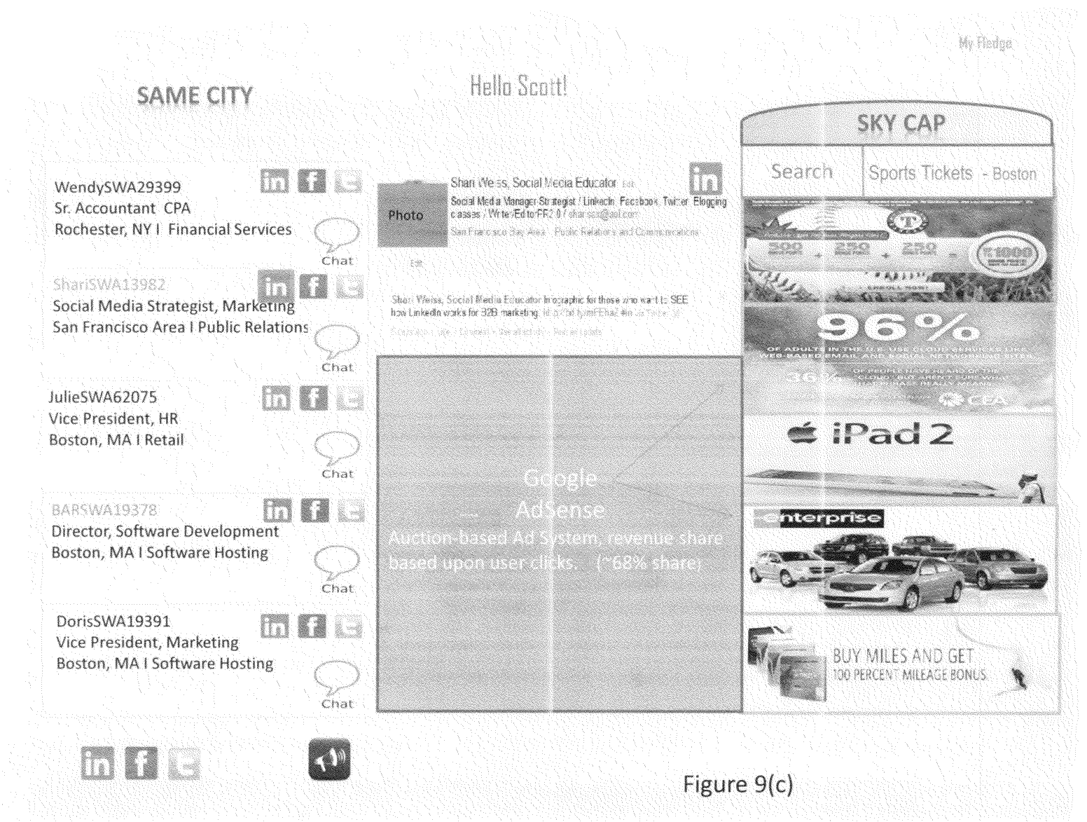

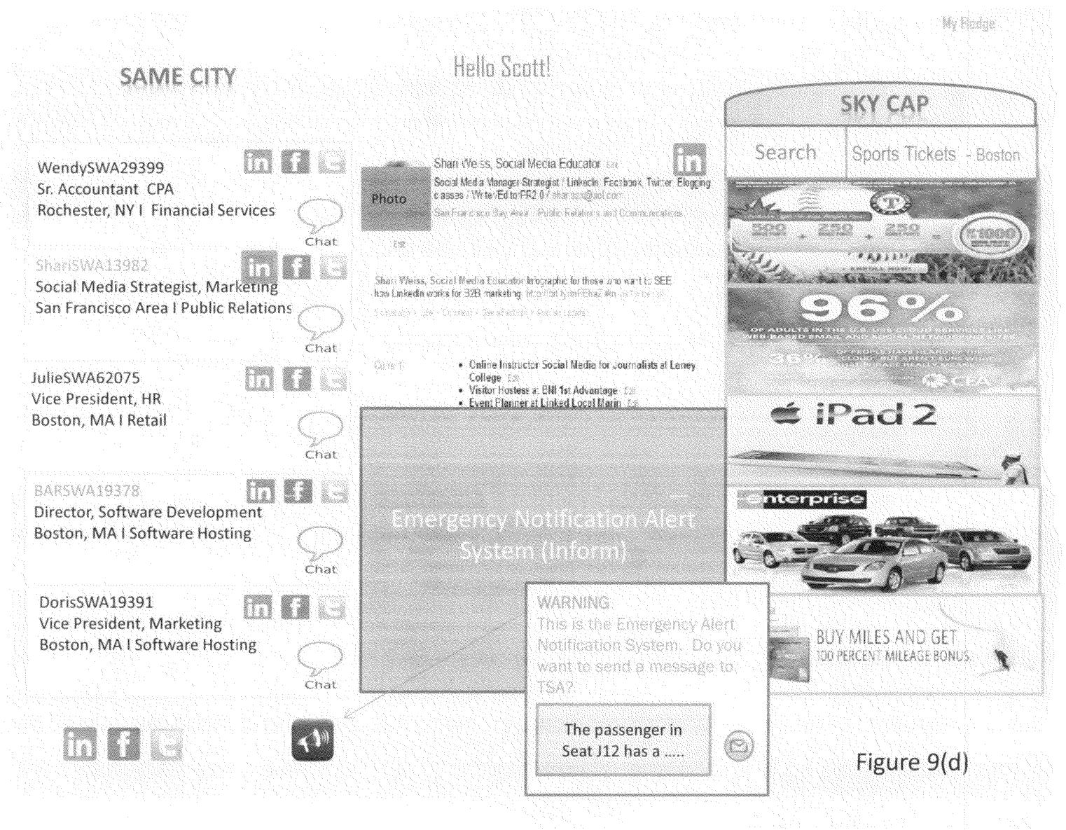

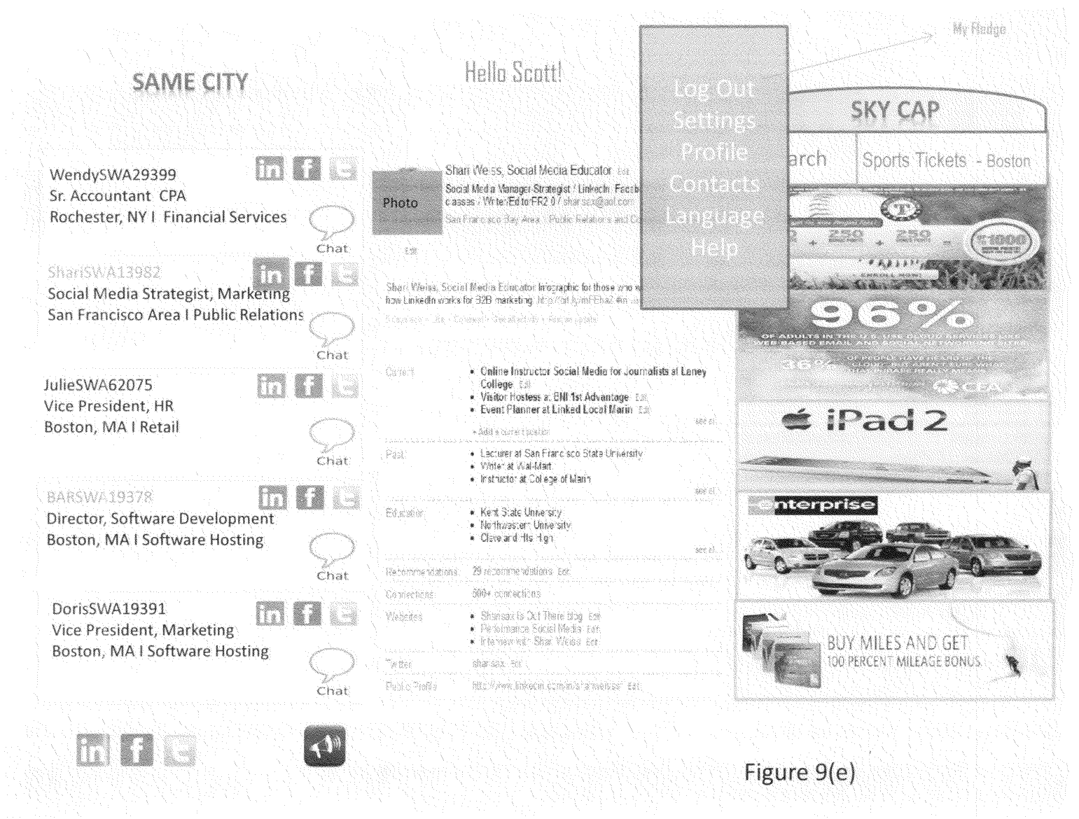

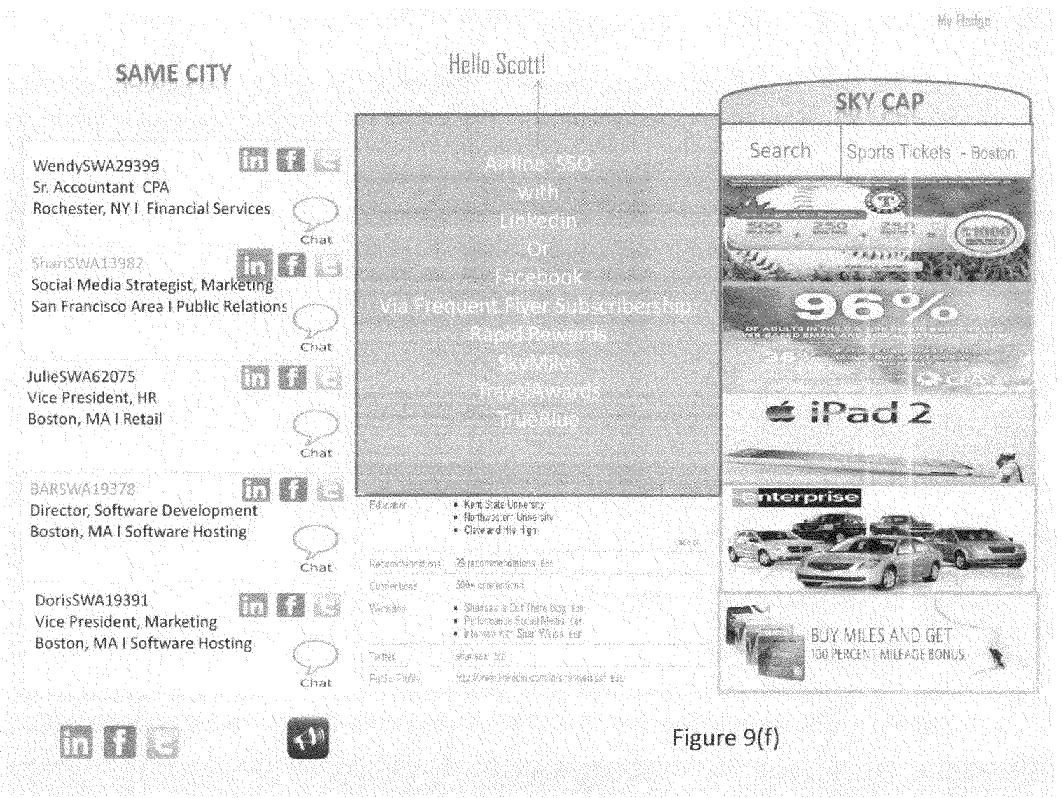

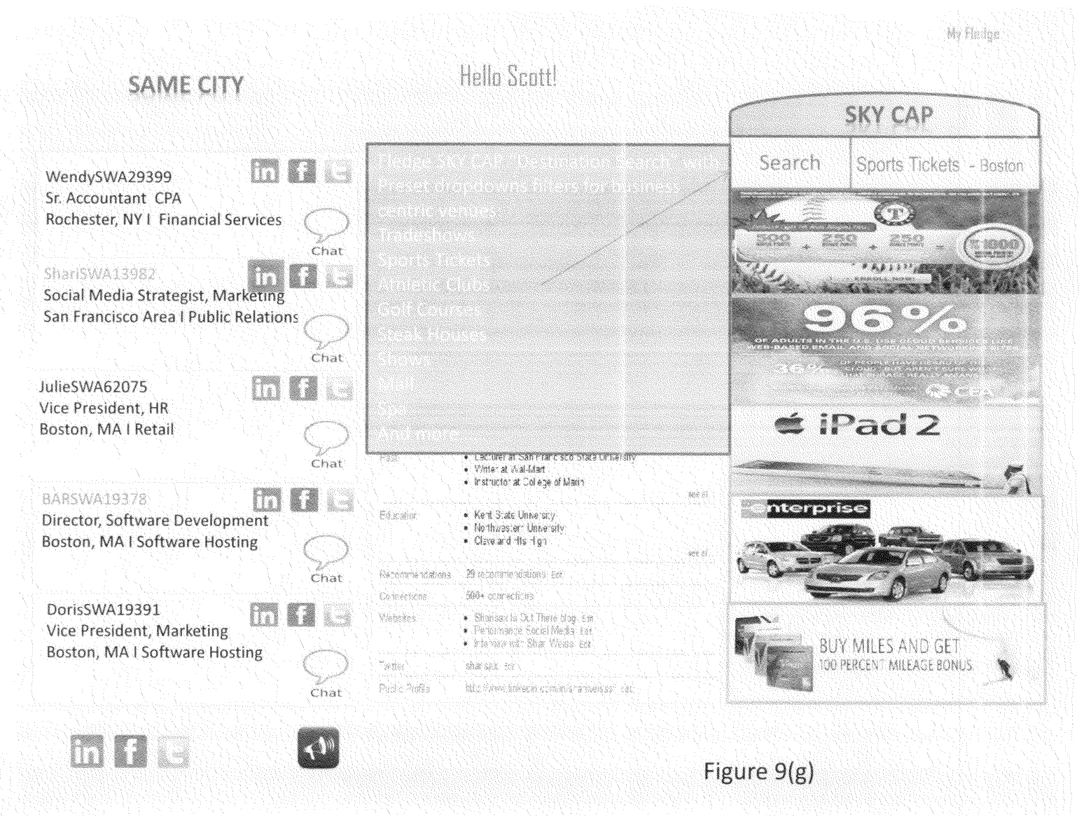

FIG. 9(a) is a representative example of the implementation of the user interface of the social network. With reference to FIG. 9(a), the user interface (900) shows the member profile section (902) with the chat functionality (910) and the public social network indicator bar (912); the public social network section (904) showing, in this example, information from the public social network Facebook for the member identified as JayceSWA62075; the advertisement section (906); and the alarm notification feature (914).

FIG. 9(b) is a representative example of the implementation of the user interface of the social network depicting use of the chat engine and a representative example of the chat display in the user interface.

FIG. 9(c) is a representative example of the implementation of the user interface of the social network highlighting the advertisement section of the user interface using Google AdSense.

FIG. 9(d) is a representative example of the implementation for the user interface of the social network highlighting the alarm notification feature and a representative example of the alarm communication display in the user interface.

FIG. 9(e) is a representative example of the implementation of the user interface of the social network highlighting an example personal settings feature selection functionality.

FIG. 9(f) is a representative example of the implementation of the user interface of the social network showing an example of the user status information.

FIG. 9(g) is a representative example of the implementation of the user interface of the social network showing an example of the categories related to the skycap feature.

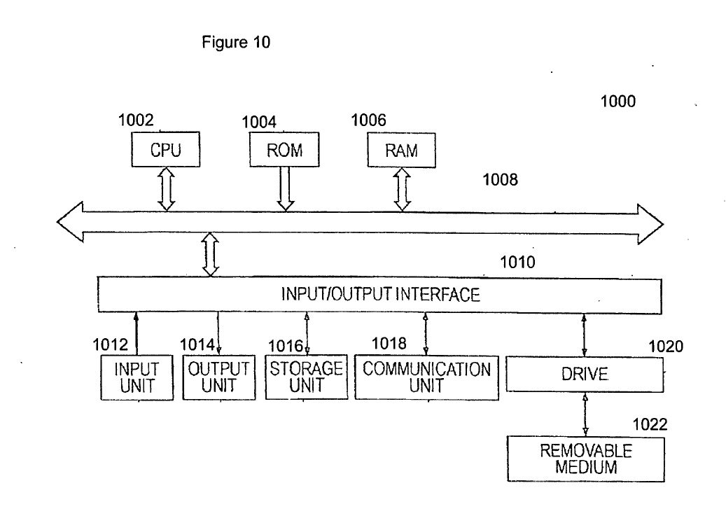

FIG. 10 illustrates an exemplary structure of a server, system, or a terminal according to an embodiment. The exemplary server, system, or terminal 1000 includes a CPU 1002, a ROM 1004, a RAM 1006, a bus 1008, an input/output interface 1010, an input unit 1012, an output unit 1014, a storage unit 1016, a communication unit 1018, and a drive 1020. The CPU 1002, the ROM 1004, and the RAM 1006 are interconnected to one another via the bus 1008, and the input/output interface 1010 is also connected to the bus 1008. In addition to the bus 1008, the input unit 1012, the output unit 1014, the storage unit 1016, the communication unit 1018, and the drive 1020 are connected to the input/output interface 1010.

The CPU 1002, such as an Intel Core™ Intel Pentium™ or Xeon™ series microprocessor or a Freescale™ PowerPC™ microprocessor, executes various kinds of processing in accordance with a program stored in the ROM 1004 or in accordance with a program loaded into the RAM 1006 from the storage unit 1016 via the input/output interface 1010 and the bus 1008. The ROM 1004 has stored therein a program to be executed by the CPU 1002. The RAM 1006 stores as appropriate a program to be executed by the CPU 1002, and data necessary for the CPU 1002 to execute various kinds of processing. The CPU 1002 may include multiple processors such as ASICs, FPGAs, GPUs, etc.

A program may include any set of instructions to be executed directly (such as machine code) or indirectly (such as scripts) by the processor. In that regard, the terms “instructions,” “steps” and “programs” may be used interchangeably herein. The instructions may be stored in object code format for direct processing by the processor, or in any other computer language including scripts or collections of independent source code modules that are interpreted on demand or compiled in advance. Functions, methods and routines of the instructions are explained in more detail below.

The input unit 1012 includes a keyboard, a mouse, a microphone, a touch screen, and the like. When the input unit 1012 is operated by the user, the input unit 1012 supplies an input signal based on the operation to the CPU 1002 via the input/output interface 1010 and the bus 1008. The output unit 1014 includes a display, such as an LCD, or a touch screen or a speaker, and the like. The storage unit 1016 includes a hard disk, a flash memory, and the like, and stores a program executed by the CPU 1002, data transmitted to the terminal 1000 via a network, and the like.

The communication unit 1018 includes a modem, a terminal adaptor, and other communication interfaces, and performs a communication process via the networks described herein.

A removable medium 1022 formed of a magnetic disk, an optical disc, a magneto-optical disc, flash or EEPROM, SDSC (standard-capacity) card (SD card), or a semiconductor memory is loaded as appropriate into the drive 1020. The drive 1020 reads data recorded on the removable medium 1022 or records predetermined data on the removable medium 1022. One skilled in the art will recognize that, although the data storage unit 1016, ROM 1004, RAM 1006 are depicted as different units, they can be parts of the same unit or units, and that the functions of one can be shared in whole or in part by the other, e.g., as RAM disks, virtual memory, etc. It will also be appreciated that any particular computer may have multiple components of a given type, e.g., CPU 1002, input unit 1012, communications unit 1018, etc. An operating system such as Microsoft Windows 7®, Microsoft Windows 8®, Linux®, Mac OS®, or Unix® may be used by the terminal. Other programs may be stored instead of or in addition to the operating system. It will be appreciated that a computer system may also be implemented on platforms and operating systems other than those mentioned. Any operating system or other program, or any part of either, may be written using one or more programming languages such as, e.g., Java®, C, C++, C#, Visual Basic®, VB.NET®, Peri, Ruby, Python, or other programming languages, possibly using object oriented design and/or coding techniques.

Data may be retrieved, stored or modified in accordance with the instructions. For instance, although the system and method is not limited by any particular data structure, the data may be stored in computer registers, in a relational database as a table having a plurality of different fields and records, XML documents, flat files, etc. The data may also be formatted in any computer-readable format such as, but not limited to, binary values, ASCII or Unicode. The textual data might also be compressed, encrypted, or both. By further way of example only, image data may be stored as bitmaps comprised of pixels that are stored in compressed or uncompressed, or lossless or lossy formats (e.g., JPEG), vector-based formats (e.g., SVG) or computer instructions for drawing graphics. Moreover, the data may comprise any information sufficient to identify the relevant information, such as numbers, descriptive text, proprietary codes, pointers, references to data stored in other memories (including other network locations) or information that is used by a function to calculate the relevant data.

It will be understood by those of ordinary skill in the art that the processor and memory may actually comprise multiple processors and memories that may or may not be stored within the same physical housing. For example, some of the instructions and data may be stored on removable memory such as a magneto-optical disk or SD card and others within a read-only computer chip. Some or all of the instructions and data may be stored in a location physically remote from, yet still accessible by, the processor. Similarly, the processor may actually comprise a collection of processors which may or may not operate in parallel. As will be recognized by those skilled in the relevant art, the terms “system,” “terminal,” and “server” are used herein to describe a computer's function in a particular context. A terminal may, for example, be a computer that one or more users work with directly, e.g., through a keyboard and monitor directly coupled to the computer system. Terminals may also include a smart phone device, a personal digital assistant (PDA), thin client, or any electronic device that is able to connect to the network and has some software and computing capabilities such that it can interact with the system. A computer system or terminal that requests a service through a network is often referred to as a client, and a computer system or terminal that provides a service is often referred to as a server. A server may provide contents, content sharing, social networking, storage, search, or data mining services to another computer system or terminal. However, any particular computing device may be indistinguishable in its hardware, configuration, operating system, and/or other software from a client, server, or both. The terms “client” and “server” may describe programs and running processes instead of or in addition to their application to computer systems described above. Generally, a (software) client may consume information and/or computational services provided by a (software) server.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A computer system for creating a social network, the computer system including at least one computer processor and computer readable storage medium or media including computer code and at least one storage device, the system comprising:
a memory comprising a member account database comprising a plurality of member accounts, each member account of said plurality of member accounts including member registration information and member travel information for a member associated with the member account;
the computer processor programmed at least to access said member account database and to establish a social network among multiple members based on said member travel information, each said member being assigned an access period during which the member is permitted access to said social network; and
said computer processor configured to be accessed by the member via a network connection to a computer device during the member's assigned access period, and
whereby, upon expiration of a member's assigned access period, the social network cannot be accessed by said member.

2. The system of claim 1, where one or more of the multiple members has the same access period.

3. The system of claim 1 where said social network comprises a member page for one or more members of the social network, said member page including some of the member registration information, said member page for being displayed on said computer device upon access to said social network.

4. The system of claim 3 where said computer processor is further configured to access one or more public social networks via the network and receive additional member information for inclusion in said member page.

5. The system of claim 1 where said member registration information includes access information for accessing one or more public social networks to which the member belongs.

6. The system of claim 1 where said travel status information in said member account is periodically updated.

7. A computer system for creating a series of social networks, the computer system including at least one computer processor and computer readable storage medium or media including computer code and at least one storage device, the system comprising:
a memory comprising a member account database comprising a plurality of member accounts, each said member account of said plurality of member accounts including member registration information and member travel information for a member associated with each account;
the computer processor programmed to access said member account database and compare member travel information of the plurality of member accounts with selected travel criteria to thereby identify a first set of member accounts including the member travel information matching said selected travel criteria and programmed to establish a social network among the first set of multiple members associated with the identified member accounts, such that each of said first set of multiple members are permitted to access said social network during a predetermined access period; and
said computer processor configured to be accessed via a network by a computer device whereby said first set multiple members are permitted access to the social network during the access period, where upon expiration of the access period, the social network will not permit access by one or more of said first set multiple members,
where said member account database is configured to receive updates to the member travel information, and said computer processor is programmed to periodically compare member travel information of said multiple member accounts with said travel criteria to thereby identify a second set of member accounts with member travel information matching said travel criteria and establish a second temporary social network among a second set of multiple members associated with the second set of identified member accounts, where said each member of second set of multiple members is permitted to access said second temporary social network during a predetermined access period.

8. The system of claim 7 where said temporary social network comprises a member page for one or more members of the temporary social network, said member page including some of the member registration information, said member page for being displayed on said computer device upon access to said temporary social network.

9. The system of claim 8 where said computer processor is configured to access one or more public social networks and receive additional member information for inclusion in said member page.

10. The system of claim 7 where said member registration information includes access information for accessing one or more public social networks to which member belongs.

11. A computer system for creating multiple social networks, the computer system including at least one computer processor and computer readable storage medium or media including computer code and at least one storage device, said computer system comprising:
a memory comprising a member account database comprising a plurality of member accounts, each said member account of said plurality of member accounts including member registration information and member travel information for a member;
the computer processor being programmed to access said member account database and programmed to create multiple member groups based on a comparison of the member travel information of multiple member accounts with selected travel criteria, each said member group having members with at least one common travel criteria,
said computer processor being programmed to establish a temporary social network for each member group, each said temporary social network being established with an access period, whereby said computer processor is configured to permit access to each temporary social network by each member of its associated member group during the temporary social network's access period; and
said computer processor being configured to be accessed via a network through use of a computer device, whereby a member of a member group may access said computer processor via the network to access the temporary social network of the member group to which member belongs,
wherein each temporary social network expires upon expiration of the temporary social network's access period.

12. The system of claim 11, where said member account database receives updates to the member travel information and said computer processor is programmed to periodically compare member travel information of multiple member accounts with said travel criteria to thereby identify a second set of member accounts with member travel information matching said travel criteria and thereafter establish a second temporary social network among a second set of multiple members associated with the second set of identified member accounts, where said second set of multiple members is permitted to access said second temporary social network during a predetermined access period.

13. The system of claim 11 where said temporary social network comprises a member page for one or more members of the social network, said member page including some of the member registration information, said member page for being displayed on said computer device upon access to said temporary social network.

14. The system of claim 13 where said computer processor is further capable of accessing one or more public social networks via a network and receiving additional member information for inclusion in said member page.

15. The system of claim 11 where said member registration information includes access information for accessing one or more public social networks to which member belongs.

16. A computer executable method for creating a series of temporary social networks using a computer system including at least one computer processor and computer readable storage medium or media including computer code and at least one storage device, the system being programmed to carry out the method comprising:
accessing a database of member accounts containing member registration information and member travel information;
comparing the travel information of the member accounts with travel criteria to thereby identify a first set of member accounts with travel information matching the travel criteria;
establishing a temporary social network among the members associated with the first set of member accounts such that each such member of the first set of members is permitted to access the social network during an access period;
updating multiple member accounts with new travel information;
comparing the new travel information of the member accounts with travel criteria to thereby identify a second set of member accounts with travel information matching the travel criteria;
permitting the second set of members to access the social network during a second access period.

17. The method of claim 16 wherein the method further comprises:
creating a member page for each member of the temporary social network using at least some of the member registration information, said member page for being displayed on a computer device upon access to said temporary social network.

18. The method of claim 17 wherein the method further comprises:
receiving additional member information for a member from one or more public social networks to which a member belongs for inclusion in said member page.

19. The method of claim 16 where said member registration information includes access information for accessing one or more public social networks to which member belongs.
